(19) United States
(12) Patent Application Publication
(10) Pub. No.: US 2025/0256453 A1
(43) Pub. Date: Aug. 14, 2025

(54) SYSTEM FOR FABRICATING FIBER-REINFORCED STRUCTURES

(71) Applicant: Caterpillar Inc., Peoria, IL (US)

(72) Inventor: Daniel Peter Sergison, East Peoria, IL (US)

(73) Assignee: Caterpillar Inc., Peoria, IL (US)

(21) Appl. No.: 18/436,451

(22) Filed: Feb. 8, 2024

(51) Int. Cl. B29C 64/118; B29C 64/194; B29C 64/209; B29C 64/218; B29C 70/38; B33Y 10/00; B33Y 30/00; B33Y 70/10

(52) U.S. Cl. CPC B29C 64/118; B29C 64/194; B29C 64/209; B29C 64/218; B29C 70/38; B33Y 70/10; B33Y 10/00; B33Y 30/00

(57) ABSTRACT

A system, for controlling a supply of a reinforcement member into a printable material extruded from a nozzle of an additive manufacturing system, includes a motor with a driveshaft defining a drive axis and an engagement portion, a feed roller mountable on the driveshaft and including a first coupler engageable with the engagement portion, an actuator including a second coupler engageable with the engagement portion, and a controller configured to actuate the motor to rotate the driveshaft about the drive axis: in a first direction to engage the engagement portion with the first coupler and transfer torque from the driveshaft to the feed roller to supply the reinforcement member into the printable material; and in a second direction to engage the engagement portion with the second coupler and transfer torque from the driveshaft to the actuator to cut-off the supply of the reinforcement member into the printable material.

### TECHNICAL FIELD

The present disclosure relates to additive construction of fiber-reinforced structures. More particularly, the present disclosure relates to a system for controlling a supply of a reinforcement member into a printable material to be extruded from an additive manufacturing system to fabricate a fiber-reinforced structure.

### BACKGROUND

Additive construction may be implemented to fabricate large-scale, three-dimensional structures (e.g., walls, buildings, barracks, etc.,) on worksites. A typical additive construction involves extruding, via a nozzle of an additive manufacturing system, a printable material (e.g., concrete, cement, asphalt, etc.,) in a layer-by-layer manner to fabricate a structure. In addition, the additive construction involves embedding reinforcement members, such as reinforced-fiber roving, within or in-between the deposited layers of the printable material to enhance the strength of the structure. Embedding the reinforcement members within or in-between the deposited layers may be labor-intensive, error-prone, and unsafe for construction workers present in the vicinity of the operating additive manufacturing system.

U.S. patent publication no. 2022/0176586 discloses a method and an apparatus for producing a concrete component, including concrete and a textile reinforcement composed of a reinforcement fiber strand. A yarn is saturated with a mineral suspension and forms the at least one reinforcement fiber strand. The reinforcement fiber strand is fed by means of a moving device, so that the reinforcement fiber strand is placed in a concrete strand, placed on a concrete layer, or placed on a vertical side surface of a plurality of concrete layers placed on top of each other, so that a perpendicular reinforcement is produced when arranged on the outside. The reinforcement fiber strand is further enclosed by the concrete immediately upon placement or subsequently before the mineral suspension has cured.

### SUMMARY OF THE INVENTION

In one aspect, the disclosure relates to a system for controlling a supply of a reinforcement member into a printable material to be extruded from a nozzle of an additive manufacturing system to fabricate a fiber-reinforced structure. The system includes a motor, a pair of feed rollers, an actuator, and a controller. The motor includes a driveshaft defining a drive axis and an engagement portion. A feed roller of the pair of feed rollers is mountable on the driveshaft. The feed roller includes a first coupler engageable with the engagement portion. the actuator includes a second coupler engageable with the engagement portion. The controller is configured to actuate the motor to rotate the driveshaft about the drive axis in a first direction to engage the engagement portion with the first coupler and transfer torque from the driveshaft to the feed roller to supply the reinforcement member into the printable material and to disengage the engagement portion with the second coupler to allow the driveshaft to rotate with respect to the actuator. Also, the controller is configured to rotate the driveshaft about the drive axis in a second direction (opposite to the first direction) to engage the engagement portion with the second coupler and transfer torque from the driveshaft to the actuator to cut-off the supply of the reinforcement member into the printable material and to disengage the engagement portion with the first coupler to allow the driveshaft to rotate with respect to the feed roller.

In another aspect, the disclosure is directed to an additive manufacturing system for fabricating a fiber-reinforced structure. The additive manufacturing system includes a support structure, a nozzle supported on the support structure and configured to extrude a printable material, a dispenser configured to dispense a reinforcement member, and a system for controlling a supply of the reinforcement member from the dispenser into the printable material flowing through the nozzle. The system includes a motor, a pair of feed rollers, an actuator, and a controller. The motor includes a driveshaft defining a drive axis and an engagement portion. A feed roller of the pair of feed rollers is mountable on the driveshaft. The feed roller includes a first coupler engageable with the engagement portion. the actuator includes a second coupler engageable with the engagement portion. The controller is configured to actuate the motor to rotate the driveshaft about the drive axis in a first direction to engage the engagement portion with the first coupler and transfer torque from the driveshaft to the feed roller to supply the reinforcement member into the printable material and to disengage the engagement portion with the second coupler to allow the driveshaft to rotate with respect to the actuator. Also, the controller is configured to rotate the driveshaft about the drive axis in a second direction (opposite to the first direction) to engage the engagement portion with the second coupler and transfer torque from the driveshaft to the actuator to cut-off the supply of the reinforcement member into the printable material and to disengage the engagement portion with the first coupler to allow the driveshaft to rotate with respect to the feed roller.

### BRIEF DESCRIPTION OF THE DRAWINGS

FIG. 1 is a perspective view of an exemplary additive manufacturing system including a nozzle for extruding a printable material, in accordance with an embodiment of the present disclosure;

FIG. 2 is a perspective view of an exemplary system for controlling a supply of a reinforcement member into the printable material to be extruded from the nozzle, in accordance with an embodiment of the present disclosure;

FIG. 3 is an exploded view of the system, in accordance with an embodiment of the present disclosure;

FIG. 4 is a cross-sectional view of the system, in accordance with an embodiment of the present disclosure;

FIG. 5 is a cross-sectional view of the system, in accordance with an embodiment of the present disclosure;

FIG. 6 illustrates an operating state of the system for supplying the reinforcement member into the printable material, in accordance with an embodiment of the present disclosure; and

FIG. 7 illustrates an operating state of the system for cutting-off the supply of reinforcement member into the printable material, in accordance with an embodiment of the present disclosure.

### DETAILED DESCRIPTION

Reference will now be made in detail to specific embodiments or features, examples of which are illustrated in the accompanying drawings. Generally, corresponding reference numbers may be used throughout the drawings to refer to the same or corresponding parts, e.g., 1, 1′, 1″, 101 and 201 could refer to one or more comparable components used in the same and/or different depicted embodiments.

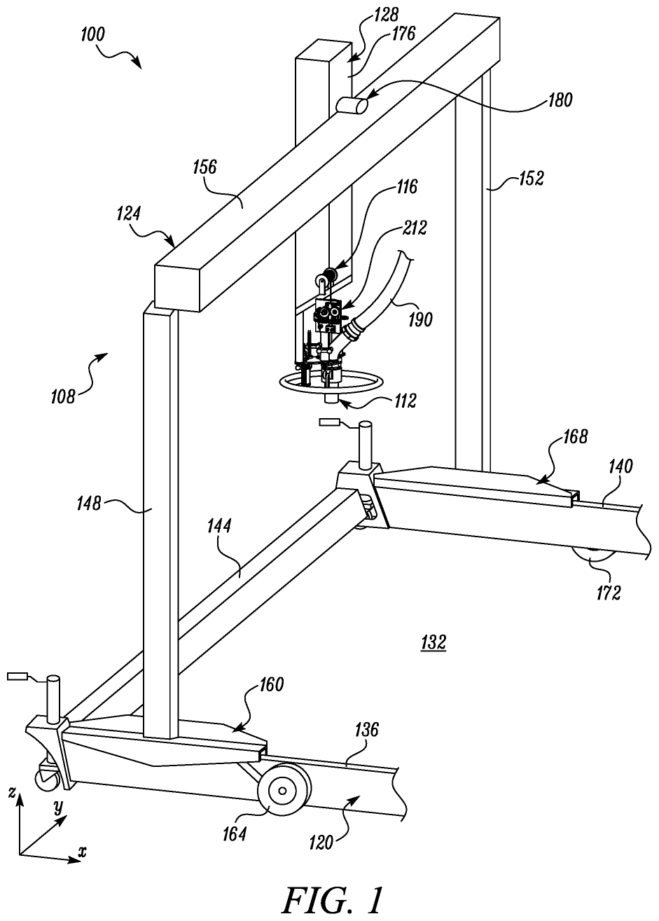

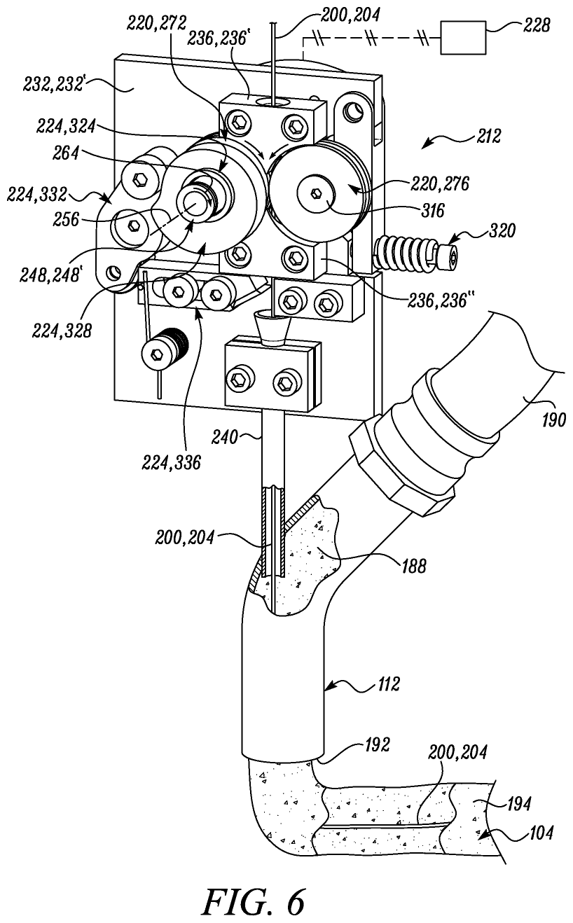

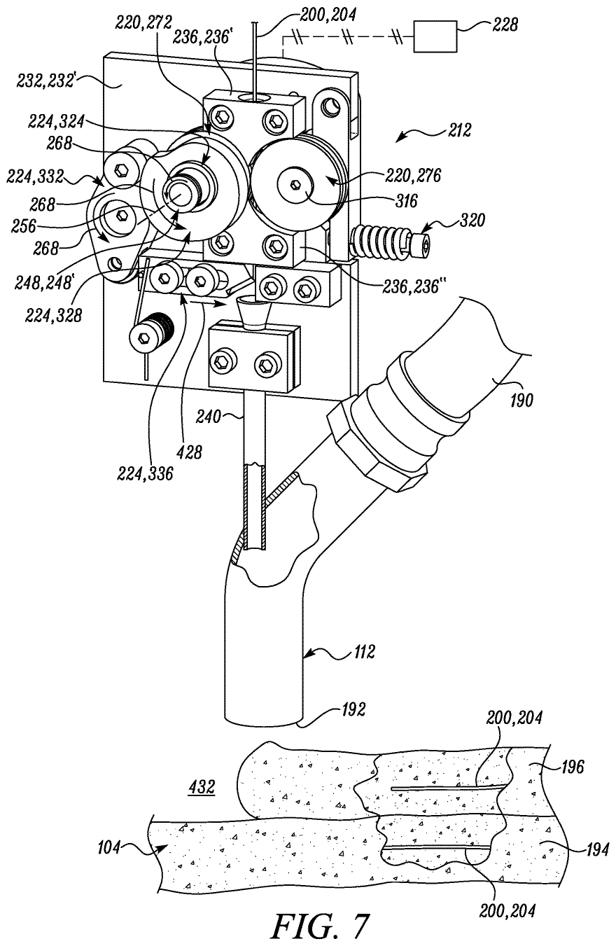

Referring to FIG. 1, an exemplary additive manufacturing system 100 is disclosed. The additive manufacturing system 100 is used to construct various types of structures (e.g., barracks, enclosures), portions of structures (e.g., walls), or other products utilizing additive manufacturing processes. In an exemplary additive manufacturing process, a printable material (e.g., concrete, cement, asphalt, etc.,) may be laid in a layer-by-layer manner to fabricate fiber-reinforced structures (e.g., a structure 104, as shown in FIGS. 6 and 7) and/or portions thereof. In an embodiment, the additive manufacturing system 100 may be a stationary system, for example, fixed to the ground of a worksite. In another embodiment, the additive manufacturing system 100 may be a portable system, for example, attached to a mobile work machine.

The additive manufacturing system 100 includes a support structure 108, a nozzle 112, and a dispenser 116. The support structure 108 accommodates and/or supports the nozzle 112 and the dispenser 116, although other known components and structures of the additive manufacturing system 100 may be supported by the support structure 108, as well. The support structure 108 facilitates relatively free movement of the nozzle 112, e.g., along x axis, y axis, and z axis, to accomplish the additive construction of the structure 104.

In an exemplary embodiment, as shown in FIG. 1, the support structure 108 includes a gantry frame 120, a gantry bridge 124, and a vertical arm 128. The gantry frame 120 may be configured to rest (or traverse) on a ground surface 132. The gantry frame 120 may include multiple components coupled together to impart a generally horizontal, substantially U-shaped profile, to the gantry frame 120. For example, as shown in FIG. 1, the gantry frame 120 includes two spaced-apart longitudinal trusses 136, 140, and a transverse truss 144. Each of the longitudinal trusses 136, 140 may extend along the x-axis. The transverse truss 144 may extend between the longitudinal trusses, along the y-axis.

The gantry bridge 124 may be supported by the gantry frame 120. For example, as shown in FIG. 1, the gantry bridge 124 includes a first vertical truss 148, a second vertical truss 152, and a horizontal truss 156. The first vertical truss 148 may be supported by (and is coupled to) the longitudinal truss 136 of the gantry frame 120. The second vertical truss 152 may be supported by (and is coupled to) the longitudinal truss 140 of the gantry frame 120. In an example, the first vertical truss 148 is attached to a first carriage assembly 160 that is movably secured (e.g., via guide wheels 164) to the longitudinal truss 136 of the gantry frame 120. The second vertical truss 152 is attached to a second carriage assembly 168 that is movably secured (e.g., via guide wheels 172) to the longitudinal truss 140 of the gantry frame 120. The first carriage assembly 160 and the second carriage assembly 168 facilitate movement of the gantry bridge 124 along the x-axis. The horizontal truss 156 may span a distance between and is coupled on opposite ends of the first vertical truss 148 and the second vertical truss 152.

The vertical arm 128 may be operatively coupled to the horizontal truss 156 to move with respect to the horizontal truss 156. In an example, as shown in FIG. 1, the vertical arm 128 is a gantry truss 176 operatively coupled to the horizontal truss 156, via a trolley 180. The trolley 180 may allow the gantry truss 176 to move with respect to the horizontal truss 156, for example, along y-axis and z-axis to position the nozzle 112 and the dispenser 116 at a desired location.

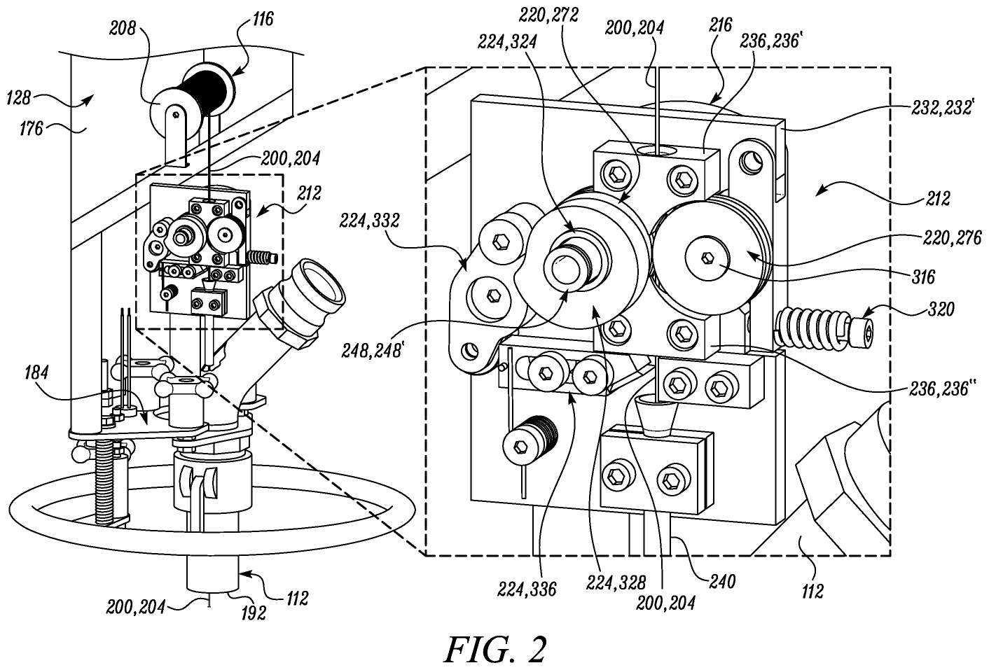

The nozzle 112 is supported on the support structure 108. In an example, as shown in FIGS. 1 and 2, the nozzle 112 is mounted to an end portion 184 of the vertical arm 128 of the support structure 108. The nozzle 112 may be fluidly coupled with a source (not shown) of printable material 188, for example, via a conduit 190 (e.g., a hose, a pipe, etc.,) (as shown in FIGS. 1, 6, and 7). The source of printable material 188 may be a mixer, hopper, tank, vessel, etc. that is configured to prepare, store, and/or contain a volume of the printable material 188. In an exemplary additive manufacturing process, the nozzle 112 receives the printable material 188 (pumped through the conduit 190) and extrudes the printable material 188, via an outlet 192, to form one or more layers (e.g., a first layer 194, a second layer 196, shown in FIG. 6 and FIG. 7) of the structure 104 and/or a portion thereof. The outlet 192 may facilitate the nozzle 112 to extrude the printable material 188 in a direction perpendicular to at least one of a preceding layers (e.g., the first layer 194, or the second layer 196), or a base surface (e.g., ground surface 132).

The dispenser 116 may be supported on the support structure 108. The dispenser 116 is configured to hold and dispense a reinforcement member 200 to be supplied and mixed with the printable material 188 within the nozzle 112. In an example, as shown in FIGS. 2, 6, and 7, the reinforcement member 200 includes a reinforced fiber roving 204, and the dispenser 116 includes a spool 208 of reinforced fiber roving 204 mounted on the vertical arm 128 of the support structure 108 at a location, for example, above the nozzle 112. Examples of the reinforced fiber roving 204 may include, but not limited to, basalt fiber roving, fiberglass roving, carbon fiber roving, aramid fiber roving, and glass-carbon hybrid roving.

To control (e.g., allow, or cut-off) a supply of the reinforcement member 200 (e.g., the reinforced fiber roving 204) from the dispenser 116 into the printable material 188 flowing through the nozzle 112, in one or more aspects of the present disclosure, a system 212 is provided. The system 212 includes a motor 216, a pair of feed rollers 220, an actuator 224, and a controller 228. In addition, the system 212 may include a base plate 232, a pair of guide blocks 236, and a guiding tube 240. Each of the base plate 232, the motor 216, the pair of feed rollers 220, the actuator 224, the pair of guide blocks 236, the guiding tube 240, and the controller 228 is discussed in detail with reference to the FIGS. 2-5.

The base plate 232 may be a flat rectangular plate 232. The base plate 232 may be mounted to the vertical arm 128 of the support structure 108. In an exemplary embodiment, as shown in FIG. 2, the base plate 232 is mounted on the gantry truss 176, for example, at a location between the dispenser 116 and the nozzle 112. The base plate 232 may be configured to support the motor 216, the pair of feed rollers 220, the actuator 224, the pair of guide blocks 236, and the guiding tube 240.

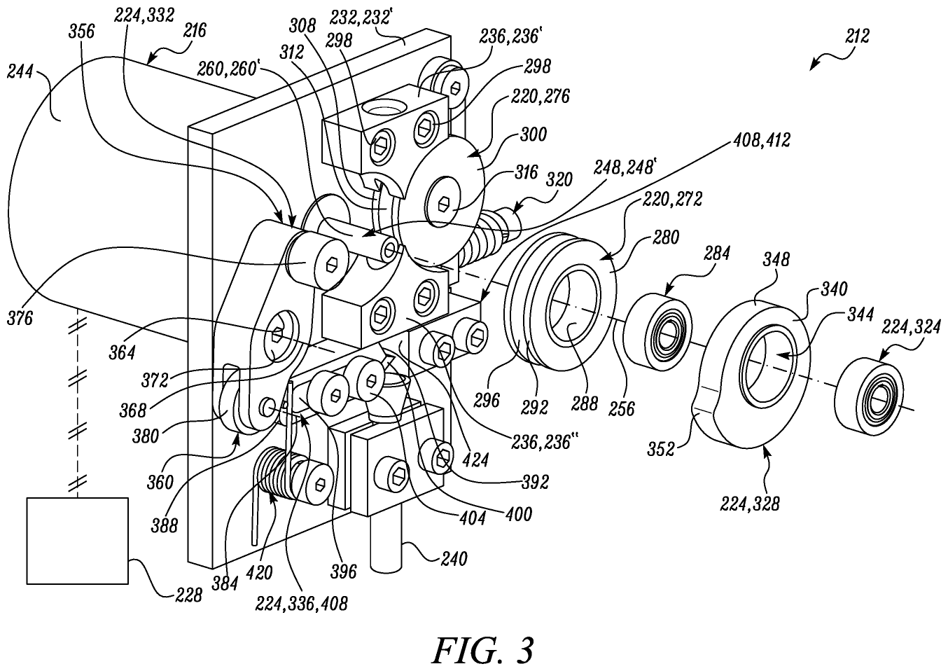

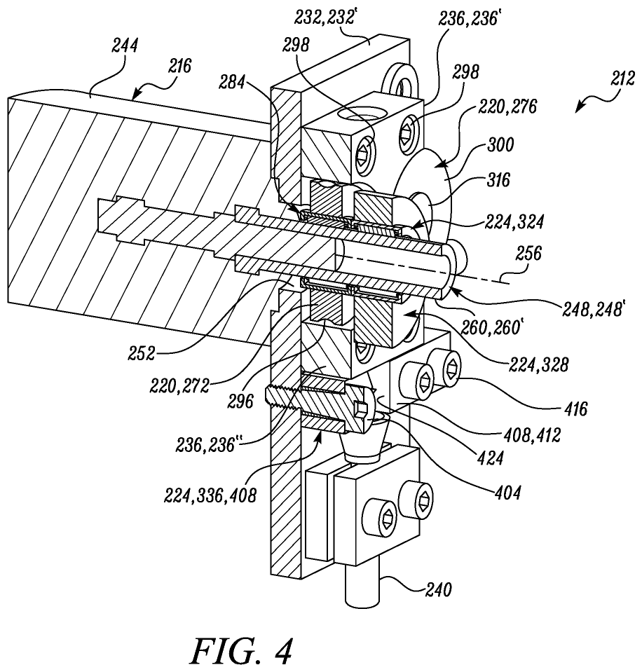

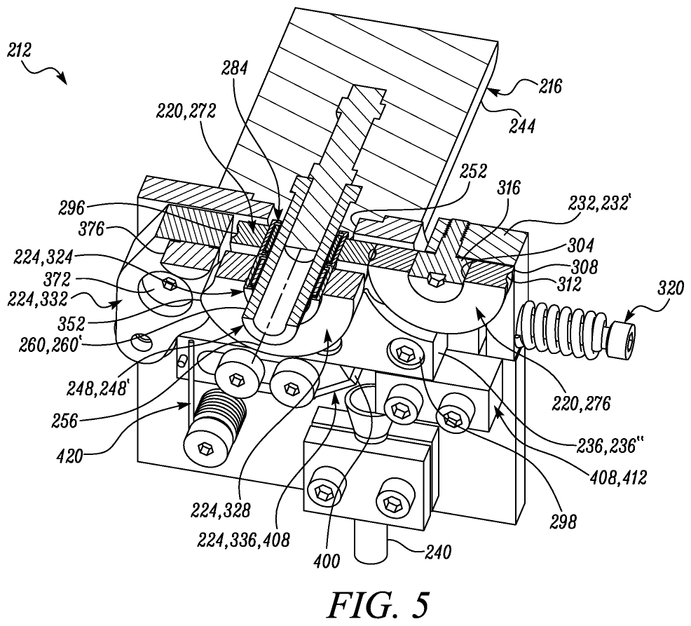

The motor 216 includes a housing 244 and a driveshaft 248. The housing 244 may be mounted to the base plate 232, for example, through a mounting plate (not shown) that is secured to the base plate 232. The driveshaft 248 may be rotatably supported on one or more bearings (not shown) within the housing 244. Although not limited, the driveshaft 248 may include a cylindrical structure 248. The driveshaft 248 may be at least partly received into a hollow opening 252 (shown in FIGS. 4 and 5) defined at the base plate 232 to facilitate the mounting of the motor 216 onto the base plate 232. The driveshaft 248 defines a drive axis 256 and an engagement portion 260. In an exemplary embodiment, as shown in FIGS. 3-5, the engagement portion 260 is an outer circumferential surface 260 of the driveshaft 248. In other embodiments, the engagement portion 260 may be any protruded portion or depression portion, or any other known geometry, formed on the outer circumferential surface 260 of the driveshaft 248.

The motor 216 is a reversible motor 216′ configured to be actuated to selectively rotate the driveshaft 248 in a first direction 264 (e.g., clockwise direction) about the drive axis 256, and in a second direction 268 opposite to the first direction 264 (e.g., an anticlockwise direction) about the drive axis 256. Further, the motor 216 may be an electrical motor (i.e., powered by one or more electrical power sources, such as batteries), or may be a hydraulic motor (i.e., powered by pressurized flow of fluid).

The pair of feed rollers 220 includes a first feed roller 272 and a second feed roller 276. The first feed roller 272 may include an annular body 280 and a first coupler 284. The annular body 280 may be a monolithic body defining a central bore 288 and an outer circumferential surface 292. In addition, the annular body 280 may define a groove 296 extending circumferentially along the outer circumferential surface 292 of the annular body 280. The groove 296 may be configured to receive the reinforcement member 200 from a first guide block 236 (of the pair of guide blocks 236) and direct the reinforcement member 200 towards a second guide block 236″ (of the pair of guide blocks 236). The first guide block 236′ and the second guide block 236″ may be secured to the base plate 232, for example, via fasteners 298 (as shown in FIG. 3).

The first coupler 284 is configured to be received and fixedly coupled to the central bore 288 of the annular body 280. The first coupler 284 facilitates the first feed roller 272 to be mounted on to the driveshaft 248. Once mounted on the driveshaft 248, the first coupler 284 is engageable or disengageable with the corresponding engagement portion 260 (e.g., the outer circumferential surface 260′) of the driveshaft 248 to selectively transfer torque between the driveshaft 248 and the first feed roller 272. In an exemplary embodiment, the first coupler 284 is a one-way clutch configured to engage with the engagement portion 260 of the driveshaft 248 upon rotation of the driveshaft 248 in the first direction 264 about the drive axis 256, and disengage with the engagement portion 260 upon rotation of the driveshaft 248 in the second direction 268 about the drive axis 256. Examples of the one-way clutch may include, but not limited to, a sprag-type one-way clutch, roller-type one-way clutch, ratchet-type one-way clutch, and pawl-type one-way clutch.

The second feed roller 276 may include an annular body 300. The annular body 300 may be a monolithic body defining a central bore 304 (see FIG. 5) and an outer circumferential surface 308. In addition, the annular body 300 may define a groove 312 extending circumferentially along the outer circumferential surface 308 of the annular body 300. The second feed roller 276 may be rotatably coupled, for example, via a fastener 316, to the base plate 232 adjacent to the first feed roller 272. Once rotatably coupled to the base plate 232, the groove 312 of the second feed roller 276 may be aligned and abutted (e.g., via a tensioner 320) against the corresponding groove 296 (of the first feed roller 272). Accordingly, the groove 312 (along with the groove 296) may receive the reinforcement member 200 from the first guide block 236′ and direct the reinforcement member 200 towards the second guide block 236″.

The actuator 224 is now discussed. The actuator 224 is configured to move between a released position (shown in FIG. 6) and an actuated position (shown in FIG. 7). In the released position, the actuator 224 allows the supply of the reinforcement member 200 into the printable material 188 flowing through the nozzle 112. In the actuated position, the actuator 224 cut-off the supply of the reinforcement member 200 into the printable material 188 flowing through the nozzle 112. The actuator 224 includes a second coupler 324. In addition, the actuator 224 may include a cam lobe 328, a lever 332, and a cutter 336.

The second coupler 324 is a one-way clutch configured to engage with the engagement portion 260 of the driveshaft 248 upon rotation of the driveshaft 248 in the second direction 268 about the drive axis 256, and disengage with the engagement portion 260 upon rotation of the driveshaft 248 in the first direction 264 about the drive axis 256. Examples of the one-way clutch may include, but not limited to, a sprag-type one-way clutch, roller-type one-way clutch, ratchet-type one-way clutch, and pawl-type one-way clutch. The cam lobe 328 may include an annular body 340. The annular body 340 may define an opening 344 and an outer peripheral surface 348. In addition, the annular body 340 may define a contacting portion 352 extending outwardly from the outer peripheral surface 348.

In an assembly of the second coupler 324 and the cam lobe 328, the second coupler 324 is received and fixedly coupled to the opening 344 of the cam lobe. Once the second coupler 324 and the cam lobe 328 are assembled together, the second coupler 324 (along with the cam lobe 328) may be mounted to the driveshaft 248. Once mounted to the driveshaft 248, the second coupler 324 is engageable with corresponding engagement portion 260 (e.g., the outer circumferential surface 260′) of the driveshaft 248 upon rotation of the driveshaft in the second direction 268 about the drive axis 256, and disengageable with the corresponding engagement portion 260 of the driveshaft 248 upon rotation of the driveshaft in the first direction 264 about the drive axis 256.

The lever 332 may define a first end portion 356 and a second end portion 360 opposite to the first end portion 356. The lever 332 may also define a shaft bore 364 defining a pivoting axis 368 (shown in FIG. 3). In an exemplary embodiment, the pivoting axis 368 is parallel to the drive axis 256. The shaft bore 364 may be formed between the first end portion 356 and the second end portion 360. The shaft bore 364 may be configured to receive a shaft 372 (secured on the base plate 232, as shown in FIG. 3) to pivotally support the lever 332 about the pivoting axis 368.

Further, the lever 332 may define a cam following portion 376 at the first end portion 356. The cam following portion 376 may be configured to contact the contacting portion 352 of the cam lobe 328. Furthermore, the lever 332 may include a roller 380 at the second end portion 360. The roller 380 is rotatable about an axis 384 to facilitate a rolling engagement between the second end portion 360 (of the lever 332) and the cutter 336 upon pivoting of the lever 332 about the pivoting axis 368.

The cutter 336 defines a first end 388, a second end 392, and a slot 396 extending between the first end 388 and the second end 392. Also, the cutter 336 includes a blade 400 located at the second end 392. The cutter 336 is slidably secured to the base plate 232, for example, via fasteners 404 received within the slot 396 and into the base plate 232. Also, the cutter 336 is operably engaged with the second end portion 360 of the lever 332. For example, the first end 388 of the cutter 336 is in rolling engagement with the roller 380 of the lever 332. In the illustrated embodiment, the cutter 336 is a part of a cutting assembly 408, that also includes a stationary block 412 secured to the base plate 232, for example, via fasteners 416.

The cutter 336 is configured to be actuated (e.g., upon pivoting of the lever 332 about the pivoting axis 368) to move (e.g., slide) from a biased position (e.g., a spring-biased position, via a spring 420, as shown in FIG. 6) to an actuated position (as shown in FIG. 7) to cut-off the supply of the reinforcement member 200. In an example, as the cutter 336 moves toward the actuated position, the blade 400 may push and abut the reinforcement member 200 against a surface 424 of the stationary block 412 to apply a shearing force on the reinforcement member 200 and cut-off the supply of the reinforcement member 200. In an exemplary embodiment, as shown in FIGS. 6 and 7, the cutter 336 moves reciprocally between the biased position and the actuated position in a third direction 428 (shown in FIG. 7). The third direction 428 may be defined at an angle with respect to the drive axis 256. In an example, the third direction 428 may be defined perpendicular to the drive axis 256.

The controller 228 is now discussed. The controller 228 may be an electronic controller that operates in a logical fashion to perform operations, execute control algorithms, store, and retrieve data and other desired operations. The controller 228 may include or access memory, secondary storage devices, processors, and any other components for running an application. The memory and secondary storage devices may be in the form of read-only memory (ROM) or random-access memory (RAM) or integrated circuitry that is accessible by the controller 228. Various other circuits may be associated with the controller 228 such as power supply circuitry, signal conditioning circuitry, driver circuitry, and other types of circuitry.

The controller 228 may be a single controller or may include more than one controller disposed to control various functions and/or features of the system 212 and/or the additive manufacturing system 100. The term “controller” is meant to be used in its broadest sense to include one or more controllers and/or microprocessors that may be associated with the system 212 and/or the additive manufacturing system 100, and that may cooperate in controlling various functions and operations of the system 212 and/or the additive manufacturing system 100. The functionality of the controller 228 may be implemented in hardware and/or software without regard to the functionality. The controller 228 may rely on one or more data maps relating to the operating conditions and the operating environment of the additive manufacturing system 100 that may be stored in the memory of or associated with the controller 228. Each of these data maps may include a collection of data in the form of tables, graphs, and/or equations.

The controller 228 is communicably coupled with the motor 216 of the system 212. As an example, by way of the controller's 228 communicable coupling with the motor 216, the controller 228 is configured to control (e.g., actuate) the motor 216 to rotate the driveshaft 248 about the drive axis 256 either in the first direction 264 (e.g., clockwise direction) or in the second direction 268 (e.g., anticlockwise direction). The controller 228 actuates the motor 216 to rotate the driveshaft 248 in the first direction 264 to engage the engagement portion 260 (of the driveshaft 248) with the first coupler 284 and to disengage the engagement portion 260 with the second coupler 324. The engagement of the driveshaft 248 with the first coupler 284 may allow the driveshaft 248 to transfer torque to the first coupler 284 to supply the reinforcement member 200 into the printable material 188 flowing through the nozzle 112. At this stage, the disengagement of the driveshaft 248 with the second coupler 324 may allow the driveshaft 248 to rotate freely with respect to the second coupler 324 (of the actuator 224) about the drive axis 256.

Alternatively, the controller 228 actuates the motor 216 to rotate the driveshaft 248 in the second direction 268 to engage the engagement portion 260 (of the driveshaft 248) with the second coupler 324 and to disengage the engagement portion 260 with the first coupler 284. The engagement of the driveshaft 248 with the second coupler 324 may allow the driveshaft 248 to transfer torque to the second coupler 324 to cut-off the supply of the reinforcement member 200 into the printable material 188 flowing through the nozzle 112. At this stage, the disengagement of the driveshaft 248 with the first coupler 284 may allow the driveshaft 248 to rotate freely with respect to the first coupler 284 about the drive axis 256. At this point, rotation of the feed rollers 220 (i.e., of both the first feed roller 272 and the second feed roller 276) may be stopped resulting in termination of the supply of the reinforcement member 200.

In some embodiments, the controller 228 may also control a pump or pump system (not shown) that is configured to pump the printable material 188 (stored within the source of the printable material 188) through the conduit 190 and the nozzle 112 during the additive manufacturing process. For example, the controller 228 may receive one or more inputs (or instructions stored on the memory of the controller 228) associated with a start of extrusion or an end of extrusion of the printable material 188 from the nozzle 112. Based on receipt of such inputs, the controller 228 may start or stop the pump (or the pump system) to control the extrusion of the printable material 188 from the nozzle 112.

Further, the controller 228 may be configured to control the supply of the reinforcement member 200 based on the receipt of the inputs (or instructions) associated with the start or end of extrusion of the printable material 188 from the nozzle 112. For instance, upon receipt of an input indicative of the start of extrusion of the printable material 188 from the nozzle 112, the controller 228 may actuate the motor 216 to rotate the driveshaft 248 in the first direction 264 to facilitate the supply of the reinforcement member 200 into the printable material 188 within the nozzle 112. In an example, the controller 228 may simultaneously send signals to the pump in order to start pumping the printable material 188 through the conduit 190 and into the nozzle 112, and to the motor in order to rotate the driveshaft 248 in the first direction 264 to start the supply the reinforcement member 200.

In another instance, upon receipt of an input indicative of approaching the end of extrusion of the printable material 188 from the nozzle 112, the controller 228 may actuate the motor 216 to rotate the driveshaft 248 in the second direction 268 so as to cut-off the supply of the reinforcement member 200 into the printable material 188 before the end of extrusion of the printable material 188 from the nozzle 112. In an example, upon receipt of an input indicative of approaching the end of extrusion of the printable material 188 from the nozzle 112, the controller 228 may actuate the motor 216 (to rotate the driveshaft 248 in the second direction 268) so as to cut-off the supply of the reinforcement member 200 into the printable material 188 five seconds before the end of extrusion of the printable material 188 from the nozzle 112. This may prevent the reinforcement member 200 to extend out from the layer(s) (e.g., from the second layer 196, as shown in FIG. 7) of the printable material 188.

Additionally, in some embodiments, the controller 228 may control position (and/or orientation) of the nozzle 112 in the three-dimensional space to form desired shape or geometry of the structure 104. In the illustrated embodiment, the nozzle 112 is oriented in a manner such that its outlet 192 extrudes the printable material 188 and the reinforcement member 200 in a direction perpendicular to at least one of a preceding layer (e.g., the first layer 194) of the printable material 188 (including the reinforcement member 200) and the base surface (e.g., ground surface 132). In order to control the positioning and orientation of the nozzle 112, the controller 228 may be configured to control movement of various components of the additive manufacturing system 100. For example, the controller 228 may be configured to control movement of the gantry bridge 124 with respect to the gantry frame 120 along the x-axis. In addition, the controller 228 may be configured to control movement of the vertical arm 128 with respect to the horizontal truss 156 along the y-axis and z-axis.

### INDUSTRIAL APPLICABILITY

The present disclosure provides the additive manufacturing system 100 for constructing various types of fiber-reinforced structures (such as the structure 104), portions of structure(s), or other products utilizing additive manufacturing processes. During a fabrication of a structure (e.g., the structure 104) using the additive manufacturing process, there may be a need to start or stop the supply of reinforcement member 200 (e.g., the reinforced fiber roving 204 dispensed from the dispenser 116) into the printable material 188 to be extruded from the nozzle 112 of the additive manufacturing system 100. For example, to fabricate a window portion 432 (shown in FIG. 7) of the structure 104 (e.g., wall), the extrusion of the printable material 188 and the reinforcement member 200 (from the nozzle 112) needs to be halted for a period (e.g. to correspondingly form a desired width of the window portion 432) while the nozzle 112 moves along a length of the structure 104. During the movement of the nozzle 112 along the length of the structure 104, upon completion of the halt period, there may be a need to resume the extrusion of the printable material 188 and the reinforcement member 200 (from the nozzle 112) to fabricate the remaining portion of the structure 104.

In order to control (e.g., allow, or cut-off) the supply of the reinforcement member 200 from the dispenser 116 into the printable material 188 flowing through the nozzle 112, for example, upon start and end of extrusion of the printable material 188 from the nozzle 112, the additive manufacturing system 100 is provided with the system 212. In an exemplary process of fabricating the structure 104 with the window portion 432 (shown in FIG. 7) using the additive manufacturing system 100, the controller 228 may initially receive an input (e.g., instruction pre-stored in the memory of the controller 228) indicative of the start of extrusion of the printable material 188 from the nozzle 112, for example, to lay-down the first layer 194 associated with the structure 104 (as shown in FIG. 6). In response to the input, the controller 228 may actuate the motor 216 to rotate the driveshaft 248 in the first direction 264 about the drive axis 256.

As the driveshaft 248 rotates in the first direction 264, the engagement portion 260 (of the driveshaft 248) engages with the first coupler 284 and disengages with the second coupler 324. This engagement between the engagement portion 260 (of the driveshaft 248) and the first coupler 284 facilitates torque transfer from the driveshaft 248 to the feed roller 220 (e.g., to the first feed roller 272). As a result, the first feed roller 272 may co-rotate with the driveshaft 248 in the first direction 264. The first feed roller 272 (rotating in the first direction 264) drives the second feed roller 276 to rotate in the second direction 268 to correspondingly receive the supply of reinforcement member 200 (dispensed from the dispenser 116) and direct the supply of reinforcement member 200 (through the grooves 296, 312) towards the second guide block 236″ (and the guiding tube 240) and into the printable material 188 flowing within the nozzle 112. The printable material 188 along with the reinforcement member 200 is then extruded from the nozzle 112 to lay-down the (reinforced) first layer 194 of the structure 104. At this stage, the driveshaft 248 rotates freely with respect to the second coupler 324 due to disengagement between the engagement portion 260 (of the driveshaft 248) and the second coupler 324.

Upon completion of the first layer 194, the nozzle 112 may be controlled (e.g., via the controller 228) to move and extrude the printable material 188 (with the reinforcement member 200) to lay-down the second layer 196 over the first layer 194. During movement of the nozzle 112 laying the second layer 196 over the first layer 194, the controller 228 may receive an input indicative of approaching end of extrusion of the printable material 188 from the nozzle 112. In response to the input associated with the end of extrusion, the controller 228 may actuate the motor 216 to rotate the driveshaft 248 in the second direction 268.

As the driveshaft 248 rotates in the second direction 268, the engagement portion 260 (of the driveshaft 248) engages with the second coupler 324 and disengages with the first coupler 284. This engagement of the driveshaft 248 with the second coupler 324 may allow the driveshaft 248 to transfer torque to the second coupler 324 to rotate the second coupler 324 in the second direction 268. This may result in rotation of the cam lobe 328 (fixedly coupled with the second coupler 324) in the second direction 268 about the drive axis 256. During the rotation of the cam lobe 328 in the second direction 268, the contacting portion 352 (of the cam lobe 328) may contact the cam following portion 376 (of the lever 332) to pivot the lever 332 in the second direction 268 about the pivoting axis 368. Upon pivoting of the lever 332 about the pivoting axis 368 in the second direction 268, the second end portion 360 (e.g., roller 380) may engage and actuate the cutter 336 from the biased position to the actuated position in the third direction 428. Upon actuation, the blade 400 (of the cutter 336) may push and abut the reinforcement member 200 against the surface 424 (of the stationary block 412) to apply the shearing force on the reinforcement member 200 and cut-off the supply of the reinforcement member 200. At this stage, the driveshaft 248 rotates freely with respect to the first coupler 284 due to disengagement between the engagement portion 260 (of the driveshaft 248) and the first coupler 284. Once the nozzle 112 moves past the desired width of the window portion 432, the controller 228 may control the pump and the motor 216 in a manner as discussed above to resume extrusion of the printable material 188 and the reinforcement member 200 from the nozzle 112 for example, to continue laying-down the second layer 196 over the first layer 194.

The system 212 offers automatedly cutting and re-feeding of the reinforcement member 200 (e.g., reinforced fiber roving 204) into the printable material 188 to be extruded from the nozzle 112 to form structures. Accordingly, the system 212 eliminates need of additional labor for placing reinforcement members (such as the reinforcement member 200) within or in-between the layers of the printable material 188 extruded by the moving nozzle 112, thereby reducing labor requirement, effort, and manufacturing cost of the structure 104, and at the same time, improving labor safety.

Unless explicitly excluded, the use of the singular to describe a component, structure, or operation does not exclude the use of plural such components, structures, or operations or their equivalents. The use of the terms “a” and “an” and “the” and “at least one” or the term “one or more,” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B” or one or more of A and B″) is to be construed to mean one item selected from the listed items (A or B) or any combination of two or more of the listed items (A and B; A, A and B; A, B and B), unless otherwise indicated herein or clearly contradicted by context. Similarly, as used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

It will be apparent to those skilled in the art that various modifications and variations can be made to the compression pad, the battery module, and/or the method of the present disclosure without departing from the scope of the disclosure. Other embodiments will be apparent to those skilled in the art from consideration of the specification and practice of the compression pad, the battery module, and/or the method disclosed herein. It is intended that the specification and examples be considered as exemplary only, with a true scope of the disclosure being indicated by the following claims and their equivalent.

What is claimed is:

1. A system for controlling a supply of a reinforcement member into a printable material to be extruded from a nozzle of an additive manufacturing system to fabricate a fiber-reinforced structure, the system comprising:
a motor comprising a driveshaft defining a drive axis and an engagement portion;
a pair of feed rollers, a feed roller of the pair of feed rollers mountable on the driveshaft and comprising a first coupler engageable with the engagement portion;
an actuator comprising a second coupler engageable with the engagement portion; and
a controller configured to actuate the motor to rotate the driveshaft about the drive axis:
in a first direction to engage the engagement portion with the first coupler and transfer torque from the driveshaft to the feed roller to supply the reinforcement member into the printable material and to disengage the engagement portion with the second coupler to allow the driveshaft to rotate with respect to the actuator, and
in a second direction opposite to the first direction to engage the engagement portion with the second coupler and transfer torque from the driveshaft to the actuator to cut-off the supply of the reinforcement member into the printable material and to disengage the engagement portion with the first coupler to allow the driveshaft to rotate with respect to the feed roller.

2. The system of claim 1, wherein the controller is configured to actuate the motor to rotate the driveshaft in the second direction to cut-off the supply of the reinforcement member into the printable material before an end of extrusion of the printable material from the nozzle.

3. The system of claim 1, wherein the controller is configured to actuate the motor to rotate the driveshaft in the first direction to supply the reinforcement member into the printable material upon receipt of an input indicative of a start of extrusion of the printable material from the nozzle.

4. The system of claim 1, wherein the first coupler is a one-way clutch configured to engage with the engagement portion of the driveshaft in the first direction and disengage with the engagement portion of the driveshaft in the second direction.

5. The system of claim 1, wherein the second coupled is a one-way clutch configured to engage with the engagement portion of the driveshaft in the second direction and disengage with the engagement portion of the driveshaft in the first direction.

6. The system of claim 1, wherein the actuator includes:
a cam lobe defining an opening configured to receive the second coupler to co-rotate the cam lobe with the second coupler when the driveshaft is rotated in the second direction about the drive axis;
a lever defining a first end portion engageable with the cam lobe to pivot the lever about a pivoting axis and a second end portion opposite to the first end portion; and
a cutter operably engaged with the second end portion, the cutter is configured to move from a biased position to an actuated position to cut-off the supply of the reinforcement member upon pivoting of the lever about the pivoting axis.

7. The system of claim 6, wherein the pivoting axis is parallel to the drive axis.

8. The system of claim 6, wherein the cutter moves reciprocally between the biased position and the actuated position in a third direction at an angle with respect to the drive axis.

9. The system of claim 6, wherein the second end portion includes a roller rotatable about an axis to facilitate a rolling engagement between the second end portion of the lever and the cutter upon pivoting of the lever about the pivoting axis.

10. The system of claim 1, wherein the reinforcement member includes a reinforced fiber roving.

11. An additive manufacturing system for fabricating a fiber-reinforced structure, the additive manufacturing system comprising:
a support structure;
a nozzle supported on the support structure and configured to extrude a printable material;
a dispenser configured to dispense a reinforcement member; and
a system for controlling a supply of the reinforcement member from the dispenser into the printable material flowing through the nozzle, the system comprising:
a motor comprising a driveshaft defining a drive axis and an engagement portion;
a pair of feed rollers, a feed roller of the pair of feed rollers mountable on the driveshaft and comprising a first coupler engageable with the engagement portion;
an actuator comprising a second coupler engageable with the engagement portion; and
a controller configured to actuate the motor to rotate the driveshaft about the drive axis:
in a first direction to engage the engagement portion with the first coupler and transfer torque from the driveshaft to the feed roller to supply the reinforcement member into the printable material and to disengage the engagement portion with the second coupler to allow the driveshaft to rotate with respect to the actuator, and
in a second direction opposite to the first direction to engage the engagement portion with the second coupler and transfer torque from the driveshaft to the actuator to cut-off the supply of the reinforcement member into the printable material and to disengage the engagement portion with the first coupler to allow the driveshaft to rotate with respect to the feed roller.

12. The additive manufacturing system of claim 11, wherein the controller is configured to actuate the motor to rotate the driveshaft in the second direction to cut-off the supply of the reinforcement member into the printable material before an end of extrusion of the printable material from the nozzle.

13. The additive manufacturing system of claim 11, wherein the controller is configured to actuate the motor to rotate the driveshaft in the first direction to supply the reinforcement member into the printable material upon receipt of an input indicative of a start of extrusion of the printable material from the nozzle.

14. The additive manufacturing system of claim 11, wherein the first coupler includes a one-way clutch configured to engage with the engagement portion of the driveshaft in the first direction and disengage with the engagement portion of the driveshaft in the second direction.

15. The additive manufacturing system of claim 11, wherein the second coupler includes a one-way clutch configured to engage with the engagement portion of the driveshaft in the second direction and disengage with the engagement portion of the driveshaft in the first direction.

16. The additive manufacturing system of claim 11, wherein the actuator includes:
a cam lobe defining an opening configured to receive the second coupler to co-rotate the cam lobe with the second coupler when the driveshaft is rotated in the second direction about the drive axis;
a lever defining a first end portion engageable with the cam lobe to pivot the lever about a pivoting axis and a second end portion opposite to the first end portion; and
a cutter operably engaged with the second end portion, the cutter is configured to move from a biased position to an actuated position to cut-off the supply of the reinforcement member upon pivoting of the lever about the pivoting axis.

17. The additive manufacturing system of claim 16, wherein the pivoting axis is parallel to the drive axis.

18. The additive manufacturing system of claim 16, wherein the cutter moves reciprocally between the biased position and the actuated position in a third direction at an angle with respect to the drive axis.

19. The additive manufacturing system of claim 16, wherein the second end portion includes a roller rotatable about an axis to facilitate a rolling engagement between the second end portion of the lever and the cutter upon pivoting of the lever about the pivoting axis.

20. The additive manufacturing system of claim 11, wherein the nozzle defines an outlet configured to extrude the printable material and the reinforcement member in a direction perpendicular to at least one of a preceding layer formed of the printable material and the reinforcement member and a base surface.
